(19) United States
(12) Patent Application Publication
(10) Pub. No.: US 2004/0115611 A1
(43) Pub. Date: Jun. 17, 2004

(54) Fit-chess physical education activity

(76) Inventor: Bruce John Greig, Ann Arbor, MI (US)

Correspondence Address: BRUCE J. GREIG, 703 DUNCAN ST., ANN ARBOR, MI, 48103-3565, US

(21) Appl. No.: 10/409,815

(22) Filed: Apr. 9, 2003

Related U.S. Application Data
(60) Provisional application No. 60/373,384, filed on Apr. 18, 2002.

(51) Int. Cl. G09B 1/00

(52) U.S. Cl. 434/433

(57) ABSTRACT

Research indicates that our nation's youth are at risk of obesity rates which are viewed as nearing epidemic proportion. As a future physical education professional, I understand the serious consequences of this dilemma regarding this population. With the increased rapidity of maturation for elementary grade children, obesity issues not only impact them “physically”, but also have severe “emotional” ramifications. These ramifications certainly will affect a child's social development, as well their over all health leading into adulthood. Using my (12 ft.×9.5 ft.) wall hanging chessboard, (which I have already manufactured) two teams of students move the Velcro attached flat chess pieces. With these factors in mind, hence the pretense for my Fit-Chess concept. By combining the “physical” elements of jumping rope, and other exercises, along with the “cognitive” elements of chess, children will achieve a perfect “balance” of the two components while participating in their daily physical education curriculum.

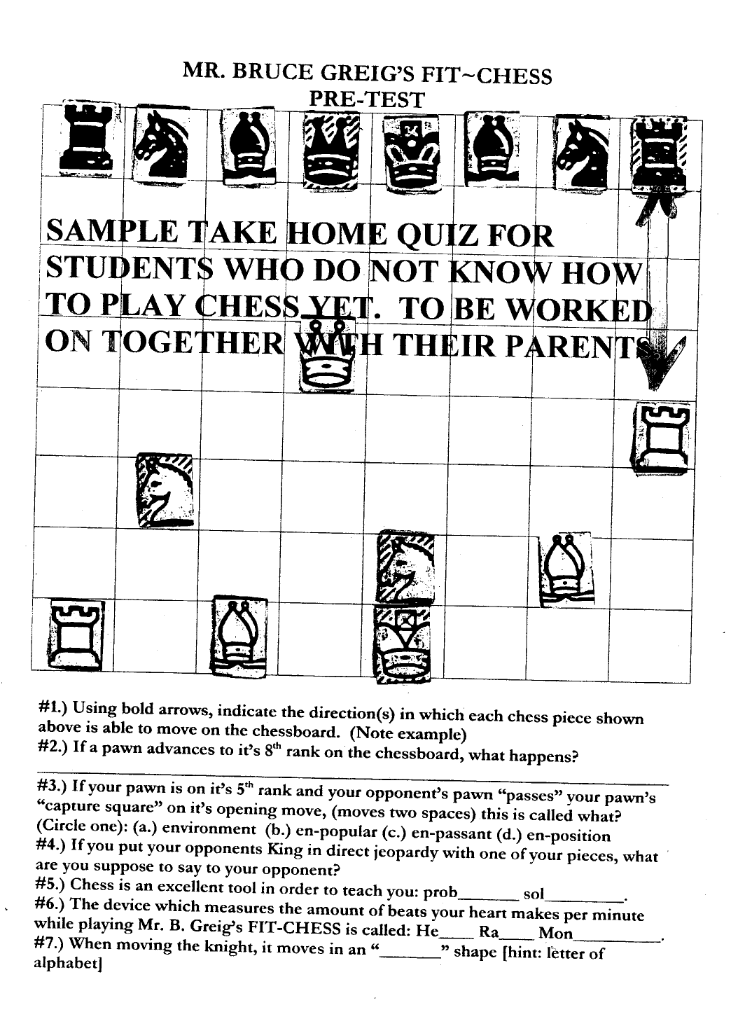

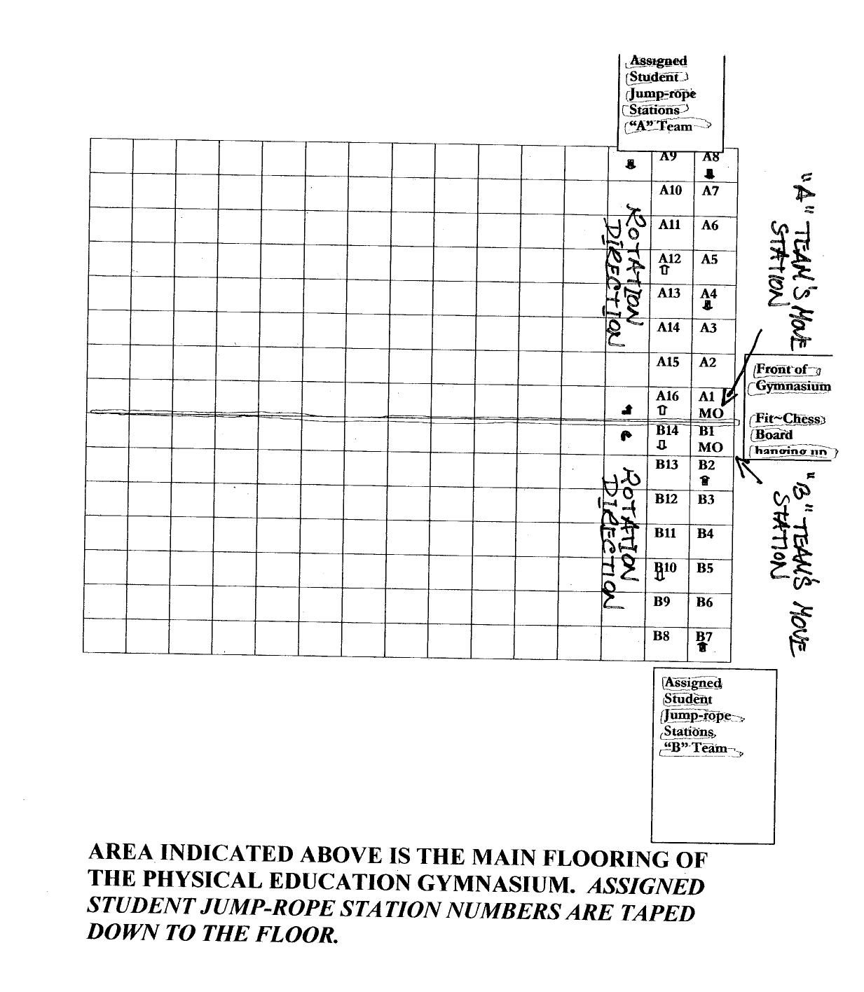

Over the past twenty years, as a student of chess, it never occurred to me that such an exercise of the “intellect” could be incorporated into a “physical” realm. As a student of physical education at Eastern Michigan University since 1997, (my method of developing creative ideas for teaching) I have at last devised the perfect marriage between the “intellectual” and the “physical”. While studying physical education at Eastern Michigan University, I have become concerned about the obesity issues which are plaguing our nation's youth today. These obesity concerns have become all the more apparent with the upsurge of computer technology, creating games for the youth, gradually replacing the physical activities which past generations took part in. I believe it is absolutely essential that physical educators now take a more proactive role in their profession, devising new and innovative methodologies (like my Fit-Chess concept) for their students to benefit from. In order to motivate all of the students (both the natural athletes and intellectuals alike) to participate in physical education, the Fit-Chess concept is a multifaceted tool in which a “Guided Discovery” rationale is used. While promoting both physical fitness, and at the same time developing an intellectual well being, both philosophies certainly go hand in hand. Now, more than ever, I am committed to making drastic changes in the physical as well as the intellectual world of my future students with this unprecedented physical education concept. Although my Fit-Chess idea is based on the historically ancient game of chess, the correlation between the intellectual and the physical are unique. By combining the two together, my students (as well as other students around the globe) will learn problem solving skills and mathematical reasoning, while at the same time achieving the cardiovascular requirements necessary for them to lead healthier lives as adults. Who knows where this concept will lead students in the future. Currently research shows that human brain utilization is only at approximately 4%. The Fit-Chess concept could very well be of a Nobel Prize magnitude one day.

The following is a description of the Fit-Chess concept: Using a large “tarp” style chess board, hanging it on the wall of the physical education gymnasium, thus allowing all of the students playing the ability to see the board more easily. I have already manufactured such a replica board. (the chess board dimensions are 12 ft.×9.5 ft.) The chess pieces are flat and attach to the board by means of Velcro. Ideally, a major toy manufacturing company could eventually purchase the rights of this new large chess game board concept. Prior to the beginning of each class, the gymnasium floor is sectioned off in half, and then into individualized jump rope “stations” with neon tape for the students to find using an A1-A20/B1-B20 team grid numbering system. (see stations rotation grid sheet) The students are met at the door of the gymnasium by their teacher who is holding some type of receptacle (like a paper bag/or box) which contains the small laminated (for durability purposes) cards with the A1-A20/B1-B20 team numbers printed on them. The students are allowed to reach into the bag and pick out one card. The number on that card indicates which team they will play for. This method eliminates either the more gifted IQ students, or the more gifted athletes from grouping themselves together on the same teams. The Fit-Chess philosophy promotes TEAM WORK Fit-Chess can also include children who may be physically (mobility impaired) or intellectually challenged. For instance, children with Cerebral Palsy can be actively involved in the game by setting up special hydraulic lift systems (like those used to load students in and out of their school buses) next to the wall chess board. A child using a wheel chair can be assisted by the teacher (or a student aid) in using the hydraulic lifts. They can also be helped in making the decision of which piece they wish to move, and also assisted by the student aid in “physically” moving the chess piece while up on the lift for safety purposes and confidence building. Using a digital LED clock near the wall chess board, there can be a “time limitation” (example: 2-minutes per move) as to how long each team can take to make moves. This will ultimately speed up the game process. Music is played during the time when each team is deciding which chess piece to move. When the music stops, (after the 2-minute interval) this is the signal for the student in the PIECE MOVE STATION to approach the wall board, climb a small ladder positioned in front of the board, (another “physical” component of the Fit-Chess philosophy) and then making their move. INDIVIDUAL DECISIONS are used when moving the chess pieces on the wall mounted board. A “team's” input of which piece to move should be strongly discouraged. Even students with visual impairments can be involved in Fit-Chess by utilizing a small magnetic chess board that contains “Braille” chess pieces, replicating the chess positions that are on the main wall board. Visually impaired students can even be encouraged to jump rope, with the assistance of the student aid. After a student makes the chess move of their choice, the entire classroom rotates to the next JUMP-ROPE STATION on the gymnasium floor. (see floor chart) When pieces are captured by the various teams (either team “A” or team “B”) the team who's piece is captured performs the designated (by the physical education teacher) exercise equivalent to the piece captured (example: Knight captured=(15)×push ups). While the team who's piece was captured is performing their “exercises”, the other team continues to accumulate revolutions by jumping rope during this time. If certain team mates are unable to complete all of the designated exercises, they are not allowed to start jumping rope again until all of their team mates who are able to complete the required exercises have themselves finished. This rule will encourage all team mates to do as many repetitions of the required exercise as they can. While waiting, the students who are unable to complete the designated exercises can perform specific leg stretches. If the physical education class should come to an end prior the completion of the game, which is currently being played, the teacher can take a picture of the wall board chess positions using a digital camera supplied by the school district. A copy of the chess piece positions can be sent home with the children on a floppy disc so that they can study the chess positions for the resumption of the game during the next class period. This way the children's parents can also see how well their children are doing in their physical education class. Eventually the Fit-chess concept might be implemented into an extracurricular school sport/activity in which different schools could compete against each other, as do other school sports today such as baseball or soccer. Using Polar heart rate monitors on the students (as is done in other physical education activities) the teacher would more accurately be able to monitor a student's heart rate for safer and more efficient utilization of the individual student's working heart rate zones. (see attached Target Heart Rate work sheet) Prior to the first day of class, two hand out sheets are to be given to the students for home work: #1.) The Fit-Chess Pre-test, which instructs students on the rules of chess, and #2.) The Determination of your Target Heart Rate work sheet. In order for a team to win in Fit-Chess, obviously the first team (either team A or B) who offers check mate to their opposition, is deemed victorious. Although a check mate scenario would determine the winner, there is a way in which the team who loses the game might be able to “reverse” their defeat via some kind of “mathematical formula” determined by the amount of actual jump rope “revolutions” that either team has made during the course of the Fit-chess contest. By “digitally” or “manually” counting the number of jump rope revolutions that each team member has made, then totaling up all of the team's combined revolutions which is greater than say, (250)- more than their opponent's total, then that team would then be deemed victorious instead, no matter who won the actual chess match via check mate. This would encourage the students to try and keep their jump ropes moving whenever possible! (example: no time would be wasted when a student approaches the wall board ladder to make their move, or when a team who has had a piece captured is required to do their designated exercise.) All time spent NOT jumping rope could ultimately effect the outcome of the chess game. Some type of digital (LED) counter on each team member's jump rope, or a manual counter on the handle of each team member's jump rope (say a re-settable counter that goes up to 10,000 revolutions on each jump rope) would make an accurate count of the totals for each team at the end of the game. (By the way, I have found a jump rope of this description out on the market that I can use) If the children are unable to jump rope any longer, (due to fatigue) it will be permissible for them to simply spin the rope at their side, in the normal jump rope motion, while marching in place until their heart rate comes back down to a normal range. (Their heart rate monitor would then stop alarming) This method also applies to a child that may be using a wheel chair, or have some other kind of mobility impairment that otherwise would not allow them to actually jump rope. The physical education teacher can use a laser light pointer during the Fit-Chess game in order to assist students who may be having difficulty deciding where to move a chess piece. The teacher would reserve the right to do this if he/she felt it necessary. A rule also would be implemented that if any team dropped their jump ropes, a (50)-revolution “penalty” would be assessed to that team due to the delicate nature of the computer jump rope counters possibly malfunctioning if being dropped repeatedly. One final angle to the Fit-Chess concept would be that during the first few “orientation” classes for the students, the physical education teacher could either demonstrate the Fit-Chess game to his/her students by means of a one-on-one “match” with one of their teacher colleagues, or call out the moves from one of the classic chess championships, say, the 1972 Robert J. Fischer vs. Boris Spassky for the class to play out on the wall chess board! By doing this, students will be able to witness first hand some premiere chess moves that they could eventually use in their own future Fit-Chess games played in Mr. Bruce J. Greig's Physical Education classes. Eventually each and every student in Mr. Bruce J. Greig's Physical education class would own there very own jump rope, (available for $15. through TANITA CORPORATION model CJ-688-TB) treating it like a precious fitness “tool”, and taking pride in maintaining it as such. Some school districts could even provide these jump ropes for their students through the school budget. In conclusion, by incorporating the innovative aspects of the “physical”, along with components of the “intellectual” during Fit-Chess, and introducing children to the musical classics like that of Bach, Beethoven, and Mozart while playing the game, I truly feel that future physical education students will have much to gain by participating in this activity.

1. I, BRUCE J. GREIG,______, claim said Fit-Chess Physical Education Activity as being new and desired to be protected by Letters Patent of the United States is as follows: A new and innovative physical education activity in which a student's “physical” and “intellectual” capabilities are maximized while jumping rope, performing other exercises, and playing chess all at the same time. The new and innovative Fit-Chess Physical Education Activity theory is proactive in nature, in that varying levels of “physically” as well as “intellectually” skilled students can work together as teams in order to achieve a common goal, that of problem solving, health, and well being. Even students with special needs can benefit from this activity. Although the game of chess itself has already been established for several centuries, by hanging my Fit-Chess game board (12 ft.×) 9.5 ft.) up on a gymnasium wall, the students will benefit from the satisfaction of jumping rope and performing common exercises, such as sit ups and push ups, while at the same time learning how to play chess. The physical education teacher can use a laser pointer in order to illustrate varying chess strategies to students who have not yet mastered the game of chess themselves. At any time during class, the physical education teacher can also adjust the designated “captured pieces exercises” according to the student's age, and stage of physical and intellectual development, as deemed necessary. (please refer to the complete description of the Fit-Chess Physical Education Activity enclosed)
